(19) United States
(12) Patent Application Publication
(10) Pub. No.: US 2009/0162715 A1
(43) Pub. Date: Jun. 25, 2009

(54) Polyisobutylene compositions with improved reactivity and properties for bonding and sealing fuel cell components

(75) Inventor: Matthew P. Burdzy, South Windsor, CT (US)

Correspondence Address: LOCTITE CORPORATION, 1001 TROUT BROOK CROSSING, ROCKY HILL, CT, 06067, US

(73) Assignee: Henkel Corporation

(21) Appl. No.: 11/549,331

(22) Filed: Oct. 13, 2006

Related U.S. Application Data
(60) Provisional application No. 60/728,730, filed on Oct. 20, 2005.

(51) Int. Cl. H01M 2/08; H01M 8/10

(52) U.S. Cl. 429/30; 429/35; 429/36

(57) ABSTRACT

An electrochemical cell, such as a fuel cell, having improved sealing against leakage includes (a) a first electrochemical cell component having a mating surface; (b) a cured sealant composition adhesively bonded to the mating surface of the first electrochemical cell component and (c) a second electrochemical cell component, having a mating surface abuttingly disposed over the cured sealant composition, The cured sealant composition includes an alkenyl terminated diallyl polyisobutylene oligomer, a silyl hardener having at least one hydrogen atom bonded to a silicon atom, a hydrosilylation catalyst and, optionally, a polyfunctional alkenyl monomer.

### FIELD OF THE INVENTION

The present invention relates to a method and a composition for bonding and sealing components of an electrochemical cell, such as a fuel cell, and an electrochemical cell formed therefrom. More particularly, the present invention relates to a method and to a polyisobutylene composition for bonding and sealing fuel cell components, such as membrane electrode assemblies, fluid flow plates, proton exchange membranes, and combinations thereof.

### BRIEF DESCRIPTION OF RELATED TECHNOLOGY

Although there are various known types of electrochemical cells, one common type is a fuel cell, such as a proton exchange membrane (“PEM”) fuel cell. The PEM fuel cell contains a membrane electrode assembly (“MEA”) provided between two flow field or bipolar plates. Gaskets are used between the bipolar plates and the MEA to provide seals thereat. Additionally, since an individual PEM fuel cell typically provides relatively low voltage or power, multiple PEM fuel cells are stacked to increase the overall electrical output of the resulting fuel cell assembly. Sealing is also required between the individual PEM fuel cells. Moreover, cooling plates are also typically provided to control temperature within the fuel cell. Such plates are also sealed to prevent leakage within the fuel cell assembly. After assembling the fuel cell stack is clamped to secure the assembly.

U.S. Pat. No. 6,875,534 to Nakamura et al. describes a cured-in-place composition for sealing a periphery of a fuel cell separator plate. The cured-in-place composition includes a polyisobutylene polymer having a terminal allyl radial at each ends, an organopolysiloxane, an organohydrogenpolysiloxane having at least two hydrogen atoms each attached to a silicon atom and a platinum catalyst. U.S. Pat. No. 6,451,468 to Adachi describes a formed-in-place composition for sealing a separator, an electrode or an ion exchange membrane of a fuel cell. The formed-in-place composition includes a linear polyisobutylene perfluoropolyether having a terminal alkenyl group at each ends, a cross-linker or hardener having at least two hydrogen atoms each bonded to a silicon atom, and a hydrosilylation catalyst. The cross-linked density and the resultant properties of these compositions are limited by using linear polyisobutylene oligomers having an allyl or alkenyl functionality of two. Functionality of these compositions is modified by varying the hydrosilyl functionality, which limits the properties of the resultant compositions.

Despite the state of the art, there remains a need for a sealant composition suitable for use with electrochemical cell components either as a cured-in-place or as a formed-in-place gasket composition.

### SUMMARY OF THE INVENTION

The present invention is directed to an electrochemical cell, such as a fuel cell, having improved sealing against leakage. The electrochemical cell includes (a) a first electrochemical cell component having a mating surface; (b) a cured sealant composition disposed over the mating surface of the first electrochemical cell component and (c) a second electrochemical cell component having a mating surface abuttingly disposed over the cured sealant composition to provide a seal thereat. The cured sealant composition advantageously includes the reaction products of a polymerizable polyisobutylene, an alkenyl terminated diallyl polyisobutylene oligomer, a silyl hardener having at least about two silicon hydride functional groups where only about one hydrogen atom bonded is to a silicon atom and a hydrosilylation catalyst. Further, the sealant composition may be adhesively bonded to the mating surface of the first electrochemical cell component.

The cured sealant composition may or may not be adhesively bonded to the mating surface of the second cell component. When the composition is adhesively bonded to the mating surface of the second cell, the composition acts as a formed-in-place gasket. When the composition is not adhesively bonded to the mating surface of the second cell, the composition acts as a cured-in-place gasket. The first cell component may vary and is typically a cathode flow field plate, an anode flow-field plate, a gas diffusion layer, an anode catalyst layer, a cathode catalyst layer, a membrane electrolyte, a membrane-electrode-assembly frame, and combinations thereof. Similarly, the second cell component is typically also a cathode flow field plate, an anode flow field plate, a gas diffusion layer, an anode catalyst layer, a cathode catalyst layer, a membrane electrolyte, a membrane-electrode-assembly frame, and combinations thereof, provided that the second cell component is different from the first cell component.

Desirably, the cured sealant composition includes a curable polyfunctional alkenyl monomer where the polyfunctional alkenyl monomer is selected from the group consisting of 1,9-decadiene and trivinylcyclohexane and combinations thereof,

In another aspect of the present invention, an electrochemical cell is provided with a cured-in-place composition. The electrochemical cell includes (a) a first electrochemical cell component having a mating surface; (b) a cured sealant composition disposed over the mating surface of the first electrochemical cell component, and (c) a second electrochemical cell component having a mating surface abuttingly disposed over the cured sealant composition to provide a seal thereat. The cured sealant composition advantageously includes an alkenyl terminated polyisobutylene oligomer; a polyfunctional alkenyl monomer; a silyl hardener having at least about two silicon hydride functional groups; and a hydrosilylation catalyst. Desirably, the alkenyl terminated polyisobutylene oligomer is an alkenyl terminated diallyl polyisobutylene oligomer. Desirably, only about one hydrogen atom bonded is to any silicon atom in the silyl hardener.

Methods for forming electrochemical cells, such as fuel cells, are also provided. In one aspect of the present invention, a method for forming an electrochemical cell includes the steps of (a) providing a first and a second electrochemical cell component each having a mating surface; (b) applying a curable sealant composition to the mating surface of at least one of the first electrochemical cell component or the second electrochemical cell component, wherein the curable sealant composition comprises an alkenyl terminated polyisobutylene oligomer; a polyfunctional alkenyl monomer; a silyl hardener having at least about two silicon hydride functional groups; and a hydrosilylation catalyst; (c) curing the sealant composition; and (d) aligning the mating surface of the second electrochemical cell component with the mating surface of the first electrochemical cell component. Desirably, the alkenyl terminated polyisobutylene oligomer is an alkenyl terminated diallyl polyisobutylene oligomer. Desirably, only about one hydrogen atom bonded is to any silicon atom in the silyl hardener.

In another aspect of the present invention, a method for forming an electrochemical cell includes the steps of (a) providing a first electrochemical cell component having a mating surface; (b) aligning a mating surface of a second electrochemical cell component with the mating surface of the first electrochemical cell component; (c) applying a curable sealant composition to at least a portion of the mating surface of at least one of the first or second electrochemical cell components, wherein the curable sealant composition includes an alkenyl terminated polyisobutylene oligomer; a silyl hardener having at least about two silicon hydride functional groups; and a hydrosilylation catalyst; and (d) curing the sealant composition to adhesively bond the first and second mating surfaces. Desirably, the alkenyl terminated polyisobutylene oligomer is an alkenyl terminated diallyl polyisobutylene oligomer. Desirably, only about one hydrogen atom bonded is to any silicon atom in the silyl hardener.

In another aspect of the present invention, a method for improving pot life in an addition curable polyisobutylene-containing composition is provided. The method includes the addition of trivinylcyclohexane into the composition. Desirably, from about 0.1 to about 40 weight percent of trivinylcyclohexane, more desirably from about 1 to about 20 weight percent of trivinylcyclohexane, is added on a total composition basis. Desirably, the method further includes the step of adding a hydrosilylation catalyst to at least about 15 molar-parts-per-million (mppm) on a total composition basis.

In another aspect of the present invention, an addition curable composition is provided. The composition includes an alkenyl terminated polyisobutylene oligomer; a polyfunctional alkenyl monomer; a silyl hardener having at least about two silicon hydride functional groups; and a hydrosilylation catalyst. Desirably, the alkenyl terminated polyisobutylene oligomer is an alkenyl terminated diallyl polyisobutylene oligomer. Desirably, only about one hydrogen atom bonded is to any silicon atom in the silyl hardener. Desirably, the composition has a silicon-hydride to alkenyl molar ratio of at least about 1.2:1 or greater. Desirably, the polyfunctional alkenyl monomer is selected from the group consisting of 1,9-decadiene, trivinylcyclohexane and combinations thereof. Desirably, the silyl hardener includes a bicyclic compound which is a reaction product of 1,9-decadiene and 2,4,6,8-tetramethylcyclotetrasiloxane.

### BRIEF DESCRIPTION OF THE DRAWINGS

FIG. 1 is a cross-sectional view of a fuel cell having an anode flow field plate, a gas diffusion layer, an anode catalyst, a proton exchange membrane, a cathode catalyst, a second gas diffusion layer, and a cathode flow field plate.

FIG. 2 is a cross-sectional of a fuel cell having a sealant disposed between a cathode flow field plate and an anode flow field plate, between the anode flow field plate and a gas diffusion layer, between a gas diffusion layer and a second cathode flow field plate, and between the second cathode flow field plate and a second anode flow field plate,

FIG. 3 is a cross-sectional of a fuel cell having a sealant disposed between a cathode flow field plate and an anode flow field plate, between the anode flow field plate and an anode catalyst, between a cathode catalyst and a second cathode flow field plate, and between the second cathode flow field plate and a second anode flow field plate.

FIG. 4 is a cross-sectional of a fuel cell having a sealant disposed between a cathode flow field plate and an anode flow field plate, between the anode flow field plate and a proton exchange membrane, between the proton exchange membrane and a second cathode flow field plate, and between the second cathode flow field plate and a second anode flow field plate.

FIG. 5 is a cross-sectional of a fuel cell having a sealant disposed between a cathode flow field plate and an anode flow field plate, between the anode flow field plate and a membrane electrode assembly, between the membrane electrode assembly and a second cathode flow field plate, and between the second cathode flow field plate and a second anode flow field plate.

FIG. 6 is a partial cross-sectional view of adjacent fuel cell components having opposed mating surfaces with a cured-in-place sealant composition disposed on one of the mating surfaces.

FIG. 7 is a partial cross-sectional view of adjacent fuel cell components of FIG. 6 having the cured-in-place sealant composition sealing both of the mating surfaces.

FIG. 8 is a partial cross-sectional view of adjacent fuel cell components having opposed mating surfaces with a cured-in-place sealant composition in the form of a bead disposed on one of the mating surfaces.

FIG. 9 is a partial cross-sectional view of adjacent fuel cell components having opposed mating surfaces with a formed-in-place sealant composition sealing both of the mating surfaces.

FIG. 10, Trivinylcyclohexane in a 10,000 Mn alkenyl functional polyisobutylene

FIG. 11, Trivinylcyclohexane in a 20,000 Mn alkenyl functional polyisobutylene

FIG. 12, Concentration affects of Catalyst on Peak Exotherm Temperature

FIG. 13, Compression Set decreases as the ratio of Si—H to Alkenyl groups Increases

FIG. 14, Heat of Reaction comparing compositions with and without Trivinylcyclohexane

FIG. 15, 1:1 Stoichiometric Ratio—Bimodal DSC with high 18 0° C. upper temperature

FIG. 16, 1.5 to 1 Stoichiometric imbalance, asymmetric curve with an upper temperature limit below 140° C.

FIG. 17, FTIR-ATR confirming the presence of Si—H in the network with excess Si—H

### DETAILED DESCRIPTION OF THE INVENTION

The present invention is directed to a method for bonding and compositions for bonding components of an electrochemical cell. As used herein, an electrochemical cell is a device which produces electricity from chemical sources, including but not limited to chemical reactions and chemical combustion. Useful electrochemical cells include fuel cells, dry cells, wet cells and the like. A fuel cell, which is described in greater detail below, uses combustion of chemicals reactants to produce electricity. A wet cell has a liquid electrolyte. A dry cell has an electrolyte absorbed in a porous medium or otherwise restrained from being flowable.

FIG. 1 shows a cross-sectional view of the basic elements of an electrochemical fuel cell, such as fuel cell 10. Electrochemical fuel cells convert fuel and oxidant to electricity and reaction product. Fuel cell 10 consists of an anode flow field plate 12 with open face coolant channels 14 on one side and anode flow channels 16 on the second side, a gas diffusion layer 18, an anode catalyst 20, a proton exchange membrane 22, a cathode catalyst 24, a second gas diffusion layer 26, and a cathode flow field plate 28 with open face coolant channels 30 on one side and cathode flow channels 32 on the second side, interrelated as shown in FIG. 1. The anode catalyst 20, the proton exchange membrane 22 and the cathode catalyst 24 combinations is often referred to as a membrane electrode assembly 36. Gas diffusion layers 18 and 26 are typically formed of porous, electrically conductive sheet material, such as carbon fiber paper. The present invention is not, however, limited to the use of carbon fiber paper and other materials may suitably be used. Fuel cells are not, however, limited to such a depicted arrangement of components. The anode and cathode catalyst layers 20 and 24 are typically in the form of finely comminuted platinum. The anode 34 and cathode 36 are electrically coupled (not shown) to provide a path for conducting electrons between the electrodes to an external load (not shown). The flow field plates 12 and 28 are typically formed of graphite impregnated plastic, compressed and exfoliated graphite; porous graphite; stainless steel or other graphite composites. The plates may be treated to effect surface properties, such as surface wetting, or may be untreated. The present invention is not, however, limited to the use of such materials for use as the flow field plates and. other materials may suitably be used. Moreover, the present invention is not limited to the fuel cell components and their arrangement depicted in FIG. 1, For example, a direct methanol fuel cell (“DMFC”) can consist of the same components shown in FIG. 1 less the coolant channels. Further, the fuel cell 10 can be designed with internal or external manifolds (not shown).

At anode 34, a fuel (not shown) traveling through the anode flow channels 16 permeates the gas diffusion layer 18 and reacts at the anode catalyst layer 20 to form hydrogen cations (protons), which migrate through the proton exchange membrane 22 to cathode 38. The proton exchange membrane 22 facilitates the migration of hydrogen ions from the anode 34 to the cathode 38. In addition to conducting hydrogen ions, the proton exchange membrane 22 isolates the hydrogen-containing fuel stream from the oxygen-containing oxidant stream.

At the cathode 38, oxygen-containing gas, such as air or substantially pure oxygen, reacts with the cations or hydrogen ions that have crossed the proton exchange membrane 22 to form liquid water as the reaction product. The anode and cathode reactions in hydrogen/oxygen fuel cells are shown in the following equations:

Anode reaction: H₂→2H⁺+2e⁻ (I)

Cathode reaction: ½O₂+2H⁺+2e⁻→H₂O (II)

In a single cell arrangement, fluid-flow field plates are provided on each of the anode and cathode sides. The plates act as current collectors, provide support for the electrodes, provide access channels for the fuel and oxidant to the respective anode and cathode surfaces, and provide channels in some fuel cell designs for the removal of water formed during operation of the cell. In multiple cell arrangements, the components are stacked to provide a fuel cell assembly having a multiple individual fuel cells. Two or more fuel cells 10 can be connected together, generally in series but sometimes in parallel, to increase the overall power output of the assembly. In series arrangements, one side of a given plate serves as an anode plate for one cell and the other side of the plate can serve as the cathode plate for the adjacent cell. Such a series connected multiple fuel cell arrangement is referred to as a fuel cell stack (not shown), and is usually held together in its assembled state by tie rods and end plates. The stack typically includes manifolds and inlet ports for directing the fuel and the oxidant to the anode and cathode flow field channels.

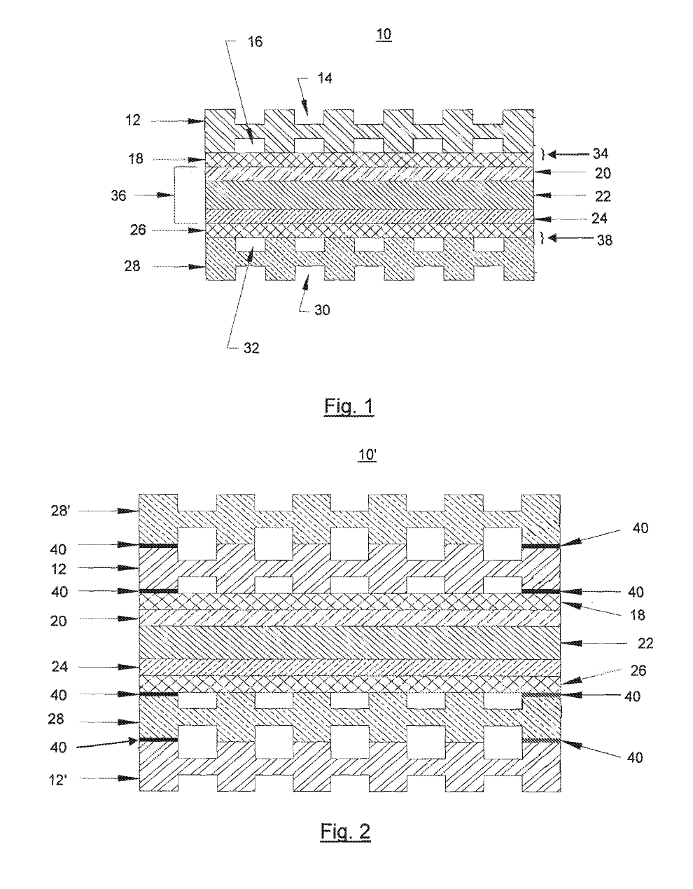

FIG. 2 shows a cross-sectional view of the basic elements of fuel cell 10 in which certain of the adjacent elements have a cured or curable composition 40 therebetween to provide a fuel assembly 10′. As depicted in FIG. 2, composition 40 seals and/or bonds the anode field plate 12 to the gas diffusion layer 18. The cathode field plate 28 is also sealed and/or bonded to the gas diffusion layer 26. In this embodiment, fuel cell assembly 10′ often has a preformed membrane electrode assembly 36 anode with the anode catalyst 20 and the cathode catalyst 24 disposed thereon. The composition 40 disposed between the various components of the fuel cell assembly 10′ may be the same composition or may be different compositions. Additionally, as depicted in FIG. 2, composition 40 may seal and/or bond the anode flow field plate 12 to a component of a second fuel cell, such as a second cathode flow plate 28′. Further, as depicted in FIG. 2, composition 40 may seal and/or bona the cathode flow field plate 28 to a component of a third fuel cell, such as a second anode flow plate 12′. In such a manner, the fuel cell assembly 10′ is formed of multiple fuel cells having components sealingly and/or adhesively adjoined to provide a multiple cell electrochemical device.

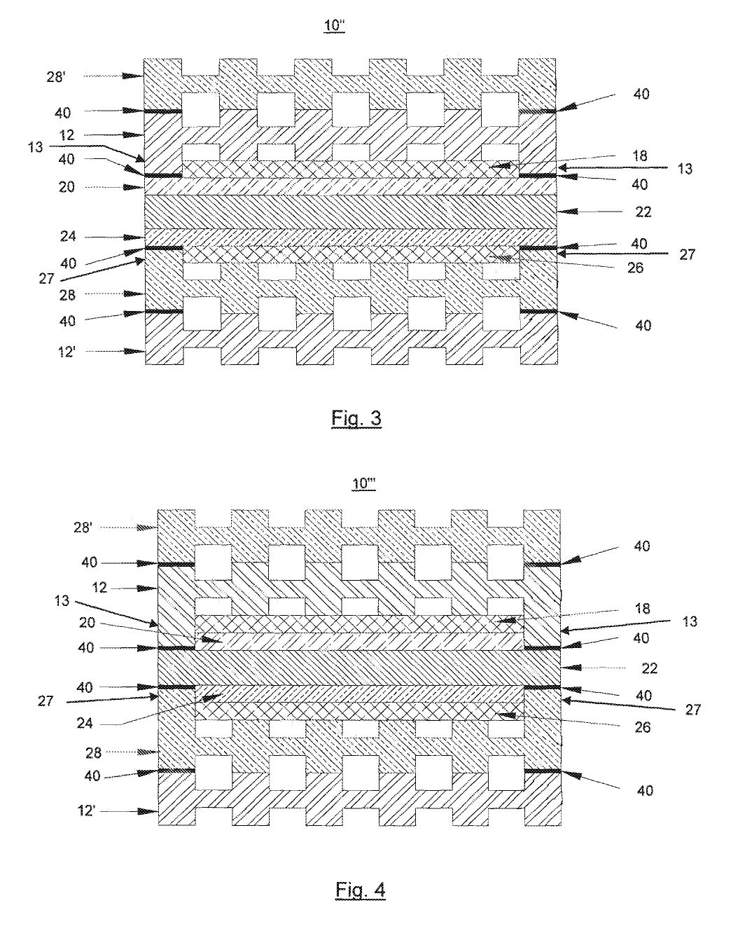

FIG. 3 shows a cross-sectional view of the basic elements of fuel assembly 10″ in which certain of the adjacent elements have a cured or curable composition 40, which may be the same or different, therebetween. In this embodiment of the present invention, the gas diffusion layer 18 is disposed between elongated terminal walls 13 of the anode flow field plate 12, and the gas diffusion layer 26 is disposed between elongated terminal walls 27 of the cathode flow field plate 28. Composition 40 is used to seal and/or bond the anode flow field plate 12 to the anode catalyst 20 and to seal and/or bond the cathode flow field plate to the cathode catalyst 24.

FIG. 4 shows a cross-sectional view of the basic elements of fuel assembly 10′″ in which certain of the adjacent elements have a cured or curable composition 40, which may be the same or different, therebetween. In this embodiment of the present invention, the gas diffusion layer 18 and the anode catalyst 20 are disposed between the elongated terminal walls 13 of the anode flow field plate 12, and the gas diffusion layer 26 and the cathode catalyst 24 are disposed between the elongated terminal walls 27 of the cathode flow field plate 28. Composition 40 is used to seal and/or bond the anode flow field plate 12 to the proton exchange membrane 22 and to seal and/or bond the cathode flow field plate to the proton exchange membrane 22.

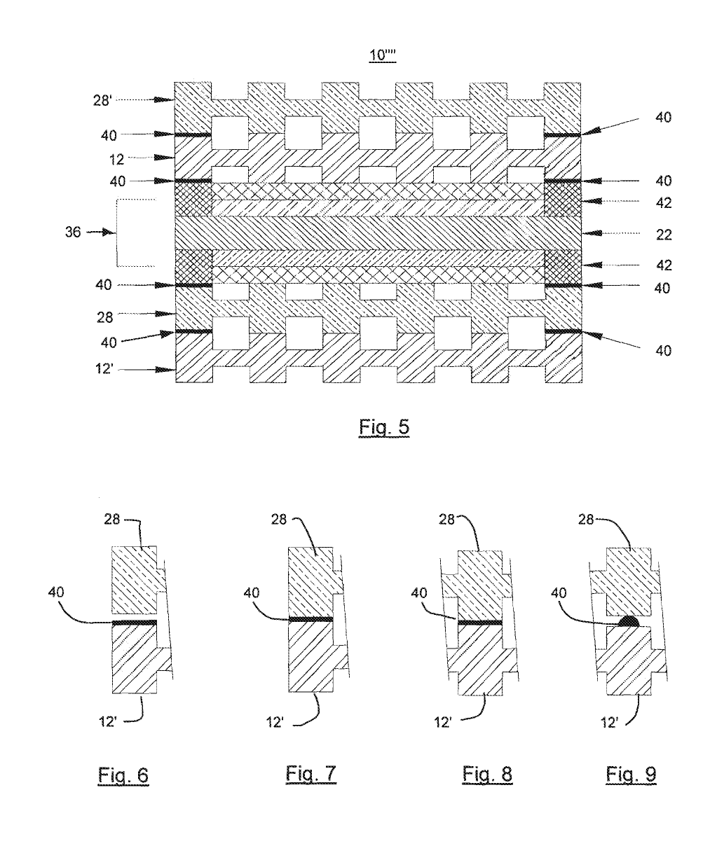

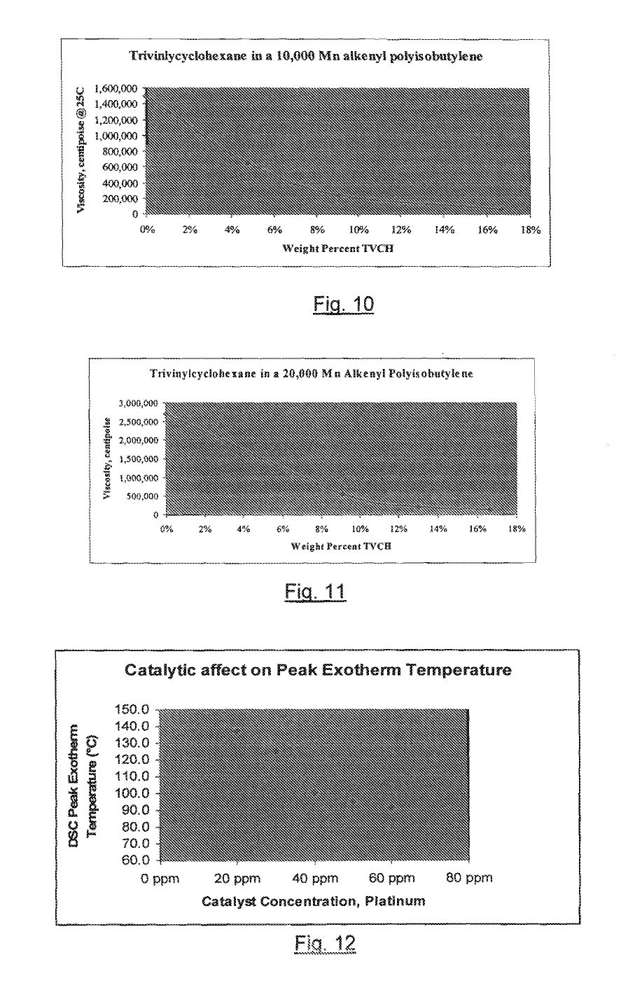

FIG. 5 shows a cross-sectional view of the basic, elements of fuel assembly 10′″ in which certain of the adjacent elements have a cured or curable composition 40, which may be the same or different, therebetween. In this embodiment of the present invention, the gas diffusion layer 18 and the anode catalyst 20 are disposed between a membrane electrode assembly-frame 42 of the membrane electrode assembly 36, and the gas diffusion layer 26 and the cathode catalyst 24 are disposed between a membrane electrode assembly frame 42 of the membrane electrode assembly 36. Composition. 40 is used to seal and/or bond, the anode flow field plate 12 to the membrane electrode assembly frame 42 and to seal and/or bond the cathode flow field-plate to the membrane electrode assembly frame 42.

Composition 40 may be a cured-in-place or a formed-in-place composition thereby acting as a cured-in-place or a formed-in-place gasket. As used herein, the phrase “cured-in-place” and it variants refer to a composition applied to the surface of one-component and cured thereat. Sealing is achieved through compression of the cured material during assembly of the one component with another component. The composition is typically-applied in precise patterns by tracing, screen-printing or the like. Moreover, the composition may be applied as a film onto a substrate. Such application techniques are amenable to large scale or large volume production. As used herein, the phrase “formed-in-place” and its variants refer to a composition that is placed between two assembled components and is cured to both components. The use of the polymerizable composition as a formed-in-place and/or as a cured-in-place gasket allows for modular or unitized fuel assembly stack designs. Desirably, the composition is a compressible composition to facilitate sealing upon assembly of the fuel assembly stack designs.

In FIGS. 6-9 the adjacent fuel cell components are shown as the cathode flow field plate 28 and the anode flow field plate 12′, however, other adjacent fuel cell components may suitably be used with the present invention. As used herein the phrase “mating surface” and its variants refer to a surface of a substrate that is proximally alignable to another substrate such that a seal may be formed therebetween.

As depicted in FIG. 6, composition 40 may be formed as a cured-in-place gasket where the composition 40 is disposed and cured onto the anode flow field plate 12′, but not curably disposed onto the cathode flow field plate 28. As depicted in FIG. 7, when the fuel assembly is assembled, the flow field plate 12′ and the cathode flow field plate 28 are compressed against one and the other whereby composition 40 acts as a cure-in-plane gasket. Composition 40 is adhesively and sealingly bonded to the flow field plate 12′, but only sealingly engages the cathode flow field plate 28, Thus, the fuel cell assembly may be easily dissembled at this junction because composition 40 is not adhesively bonded to the cathode flow field plate 28.

As depicted in FIG. 8, composition 40 may be a formed-in-place composition where the composition 40 sealingly and adhesively bonds the cathode flow field plate 28 to the flow field plate 12′. As depicted in FIGS. 6-8, the composition 40 is shown as being a flat planar strip. The present invention, however, is not so limited.

As depicted in FIG. 9, composition 40 is a cure-in-place gasket and disposed as a bead onto the anode flow field plate 12′. The composition 40 sealingly engages the cathode flow field plate 28 upon assembly of the fuel cell components. The present invention, however, is not so limited and other shapes, such as mating surfaces having protrusions and/or notches, may suitably be used.

Further, the composition 40 may be applied to the periphery or periphery portions of a fuel cell component. Desirably, the composition 40 not only covers the periphery of a fuel cell component, but also extends beyond of the perimeter or peripheral edges of the fuel cell component. As such, a fuel cell component having the composition 40 disposed and extended about its periphery or a portion of its periphery may be matingly aligned with another fuel cell component to sealingly engage the two components. In other words, the peripheral surfaces of fuel cell components may also be mating surfaces to which the inventive compositions may be applied for sealing engaging the fuel cell components.

Desirably, the cured sealant composition used in the present invention includes an alkenyl terminated polyisobutylene oligomer, for example an alkenyl terminated diallyl polyisobutylene oligomer; optionally, a polyfunctional alkenyl monomer; a silyl hardener or cross-linker having at least one hydrogen atom bonded to a silicon atom; and a hydrosilylation catalyst. Desirably, only about one hydrogen atom bonded is to any silicon atom in the silyl hardener.

The inventive compositions of the present invention have modified molecular structures, resulting in enhanced mechanical properties, cross-link densities and heats of reaction. The compositions of the present invention may be represented by the expression of (A−A+A_{f}+B_{f}), where “A−A [symbol] represents the alkenyl groups of the alkenyl terminated diallyl polyisobutylene oligomer, i.e., a difunctional alkenyl polyisobutylene (“PIB”), “A” represents an alkenyl group, “B” represents a Si—H group and [symbol] f [symbol] refers to the number of corresponding functional groups.

When both the alkenyl and hydride are di-functional, the polymerization yields a linear structure. The number of functional hydride groups in such a linear structure, however, limits the overall functionality and cross-linked density of the reacted network. By incorporating three or more alkenyl groups onto a single monomer or oligomer the cross-linking density increases and mechanical properties are improved.

One useful polyfunctional alkenyl monomer having three or more alkenyl groups is trivinylcyclohexane, which has the below chemical formula:

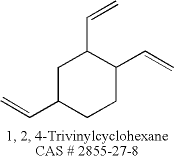

Trivinylcyclohexane is a low viscosity (1.3 mPas), tri-functional monomer. It has a molar mass of 162.3 grams per mole. The present invention, however, is not limited to the use of a tri-functional monomer, and monomers with more than three alkenyl groups may suitably be used with the inventive compositions.

One useful polyfunctional alkenyl monomer having two alkenyl groups is 1,9-decadiene (CAS # 1647-16-1). It has a molecular weight of 138.25 grams per mole.

The polyfunctional alkenyl monomer or a combination of alkenyl monomers may be present in amounts from about 0.01 weight percent to about 90 weight percent on a total composition basis.

Desirably, the polyfunctional alkenyl monomer or a combination of alkenyl monomers may be present in amounts from about 0.1 weight percent to about 50 weight percent on a total composition basis. More desirably, the polyfunctional alkenyl monomer or a combination of alkenyl monomers may be present in amounts from about 1 weight percent to about 20 weight percent on a total composition basis, including from about 1 weight percent to about 10 weight percent on a total composition basis.

Compatibility is an important issue and it is desirable to incorporate only those multi-functional monomers that are compatible with the difunctional oligomer of the resent invention. Multifunctional monomers that separated into two-phases are not compatible. Trivinylcyclohexane has been completely compatible with the polyisobutylene resin of the present invention. At weight percentages of up to about 20 weight percent trivinylcyclohexane, the resulting compositions of the present invention form clear single-phase solutions when mixed with the alkenyl resin.

Useful dialkenyl terminated linear poly(isobutylene) oligomers are commercially available from Kaneka Corporation, Osaka, Japan as EP200A, EP400A and EP600A. The three oligomers have the same functionality and have different molecular weights. EP200A, EP400A and EP600A have an approximate molecular weight (Mn) of 5,000; 10,000 and 20,000 respectively, The oligomers vary in viscosity from 944,300 centipoise (“cps”), 1,500,000 cps to 2,711,000 cps at 25° C., respectively. The oligomers are clear water white to light straw color.

The compositions of the present invention may also include a silicone having at least two reactive silicon hydride functional groups, i.e., at least two Si—H groups. This component functions as a hardener or cross-linker for the alkenyl terminated diallyl polyisobutylene oligomer. In the presence of the hydrosilation catalyst, the silicon-bonded hydrogen atoms in the cross-linking component undergo an addition reaction, which is referred to as hydrosilation, with the unsaturated groups in the reactive oligomer. Since the reactive oligomer contains at least two unsaturated groups, the silicone cross-linking component may desirably contain at least two silicon-bonded hydrogen atoms to achieve the final cross-linked structure in the cured product. The silicon-bonded organic groups present in the silicone cross-linking component may be selected from the same group of substituted and unsubstituted monovalent hydrocarbon radicals as set forth above for the reactive silicone component, with the exception that the organic groups in the silicone cross-linker should be substantially free of ethylenic or acetylenic unsaturation. The silicone cross-linker may have a molecular structure that can be straight chained, branched straight chained, cyclic or networked.

The silicone cross-linking component may be selected from a wide variety of compounds, that desirably conforms to the formula below:

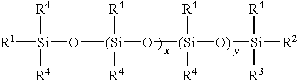

wherein at least two of R¹, R² and R³ are H; otherwise R¹, R² and R³ can be the same or different and can be a substituted or unsubstituted hydrocarbon radical from C₁₋₂₀ such hydrocarbon radicals including alkyl, alkenyl, aryl, alkoxy, alkenyloxy, aryloxy, (meth)acryl or (meth)acryloxy; thus the SiH group may be terminal, pendent or both; R⁴ can also be a substituted or unsubstituted hydrocarbon radical from C₁₋₂₀, such hydrocarbon radicals including a C₁₋₂₀ alkyl, alkenyl, aryl, alkoxy, alkenyloxy, aryloxy, (meth)acryl or (meth)acryloxy, and desirably is an alkyl group such as methyl; x is an integer from 10 to 1,000; and y is an integer from 1 to 20. Desirably, R² and R³ are not both hydrogen, i.e., R¹ is H and either R² or R³, but not both, is H. Desirably, R groups which are not H are methyl. The silicon hydride crosslinker should be present in amounts sufficient to achieve the desired amount of crosslinking and desirably in amounts of about 0.5 to about 40 percent by weight of the composition, more desirably from about 1 to about 20 percent by weight of the composition.

A bicyclic cross-linking compound was prepared in a single step reaction and was compatible with functional hydrocarbon elastomers of the present invention. Two moles of 2,4,6,8-tetramethylcyclotetrasiloxane was reacted with one mole of 1,9-decadiene in the presence of a catalyst to yield a liquid hydride that is compatible with hydrocarbon oligomers and reacts with alkenyl oligomers to form elastomers that are useful for sealing fuel cells and the like. Such useful bicyclic cross-linking compounds are useful with the practice of the present invention. The present invention, however, is not so limited and other bicyclic chemical structures, such as fluoroethers and the like, may suitably be used. The bicyclic crosslinker should be present in amounts sufficient to achieve the desired amount of crosslinking and desirably in amounts of about 0.5 to about 40 percent by weight of the composition, more desirably from about 1 to about 20 percent by weight of the composition.

The structure of the bicyclic cross-linking agent of the present invention is the reaction product of 1,9-decadiene and 2,4,6,8-tetramethylcyclotetrasiloxane, as shown below:

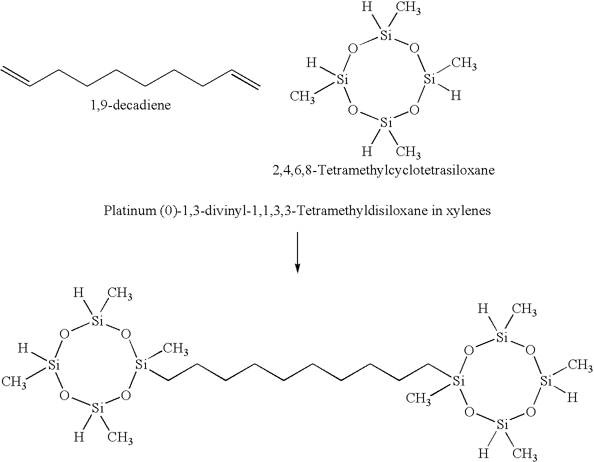

Useful platinum catalysts include platinum or platinum-containing complexes such as the platinum hydrocarbon complexes described in U.S. Pat. Nos. 3,159,601 and 3,159,662; the platinum alcoholate catalysts described in U.S. Pat. No. 3,220,972, the platinum complexes described in U.S. Pat. No. 3,814,730 and the platinum chloride-olefin complexes described in U.S. Pat. No. 3,516,946. Each of these patents relating to platinum or platinum-containing catalysts are hereby expressly incorporated herein by reference. Desirably, the platinum or platinum-containing complex is dicarbonyl platinum cyclovinyl complex, platinum cyclovinyl complex, platinum divinyl complex, or combinations thereof.

### EXAMPLES

### Example 1

### Viscosity Data

Trivinylcyclohexane was very affective in reducing the viscosity of alkenyl functional polyisobutylene resins. Viscosity reduction was observed in a 5,000; 10,000 and 20,000 number average molecular weight (Mn) alkenyl functional polyisobutylene. Details are shown in FIG. 11, FIG. 12, Table 1 and Table 2 for a 10,000 and 20,000 molecular weight alkenyl functional polyisobutylene for inventive compositions 2 through 4 and 6 through 8 and for comparative compositions 1 and 5.

TABLE 1
Effect Of Trivinylcyclohexane On Viscosity
In A 10,000 Mn Alkenyl Functional Polyisobutylene

| | Compar. | Inv. | Inv. | Inv. |
|---|---|---|---|---|
| Description | Comp. 1 | Comp. 2 | Comp. 3 | Comp. 4 |
| Alkenyl Terminated | 50 | 50 | 50 | 50 |
| Polyisobutylene (10,000 | | | | |
| Mn), weight parts | | | | |
| Trivinylcyclohexane, | 0 | 2.5 | 5 | 10 |
| weight parts | | | | |
| Viscosity (Haake, 150 | 1,500,000 | 650,500 | 234,000 | 67,500 |
| RheoStress), centipoise | | | | |
| Shear Rate [1/s] | 12 | 12 | 12 | 12 |
| Temperature, ° C. | 25 | 25 | 25 | 25 |

TABLE 2
Effect Of Trivinylcyclohexane On Viscosity
In A 20,000 Mn Alkenyl Functional Polyisobutylene

| | Compar. | Inv. | Inv. | Inv. |
|---|---|---|---|---|
| Description | Comp. 5 | Comp. 6 | Comp. 7 | Comp. 8 |
| Alkenyl Terminated | 50 | 50 | 50 | 50 |
| Polyisobutylene (20,000 | | | | |
| Mn), weight parts | | | | |
| Trivinylcyclohexane, | 0 | 5 | 7.5 | 10 |
| weight parts | | | | |
| Viscosity (Haake, 150 | 2,711,000 | 561,000 | 212,750 | 127,500 |
| RheoStress), centipoise | | | | |
| Shear Rate [1/s] | 12 | 12 | 12 | 12 |
| Temperature, ° C. | 25 | 25 | 25 | 25 |

Trivinylcyclohexane was effective in reducing the viscosity of the alkenyl functional polyisobutylene resins. The resultant inventive compositions did not separate, and trivinylcyclohexane concentrations of up to about 20 weight percent with the alkenyl functional polyisobutylene resins formed clear single-phase solutions or compositions.

### Example 2

### Differential Scanning Calorimeter (DSC) and Stability Results

Formulations were prepared with and without trivinylcyclohexane while keeping the molar ratio of Si—H to alkenyl groups and platinum to alkenyl groups constant. Comparative composition 9 shown below in Table 3 was prepared without any trivinylcyclohexane and cured. The composition had a heat of reaction of 29 joules per gram. Inventive compositions 10 through 14, which have different amounts of platinum catalyst, contained five weight percent of trivinylcyclohexane based on 100 grams of alkenyl polyisobutylene. The heat of reaction increased to about 83 joules per gram for the inventive compositions containing trivinylcyclohexane.

TABLE 3
Trivinylcyclohexane Addition To Difunctional Resins

| | | Inv. | Inv | Inv. | Inv. | Inv. |
|---|---|---|---|---|---|---|
| | Compar. | Comp. | Comp. | Comp. | Comp. | Comp. |
| Description | Comp. 9 | 10 | 11 | 12 | 13 | 14 |
| Alkenyl Terminated | 100 | 100 | 100 | 100 | 100 | 100 |
| Polyisobutylene | | | | | | |
| (5,000 Mn), weight | | | | | | |
| parts | | | | | | |
| Polyalkyl Hydrogen | 10.0 | 33.2 | 33.2 | 33.2 | 33.2 | 33.2 |
| Siloxane (2,230 Mn) (1), | | | | | | |
| weight parts | | | | | | |
| Trivinylcyclohexane, | | 5 | 5 | 5 | 5 | 5 |
| weight parts | | | | | | |
| Platinum Catalyst(2), | 0.0073 | 0.0223 | 0.0334 | 0.0425 | 0.0557 | 0.0668 |
| weight parts | | | | | | |
| Parts per million of | 20 | 20 | 30 | 40 | 50 | 60 |
| Platinum per Alkenyl | | | | | | |
| Group (mppm) | | | | | | |
| Molar Ratio of Si—H to | 1.5:1 | 1.5:1 | 1.5:1 | 1.5:1 | 1.5:1 | 1.5:1 |
| Alkenyl | | | | | | |
| Exotherm Start (° C.) | 68 | 107 | 94 | 72 | 66 | 70 |
| Exotherm Peak (° C.) | 97 | 1.7 | 125 | 100 | 95 | 92 |
| Exotherm End (° C.) | 130 | 187 | 180 | 152 | 145 | 140 |
| Heat of Reaction | 29.1 | 83.1 | 81.7 | 79.9 | 80.4 | 83.0 |
| (Joules per gram) | | | | | | |

(1) CR-300, Available from Kaneka Corporation, Osaka, Japan.
(2)0.1M Platinum (0)-1,3-Divinyl-1,1,3,3-tetramethyldisiloxane complex in xylene

The addition of trivinylcyclohexane increased the peak exotherm of the reaction from 96° C. to 137° C. as shown in Table 3. This was unexpected since vinyl groups are typically more reactive than allyl groups. The addition of trivinylcyclohexane provided some, very desirable and unexpected results, which will be reviewed below. Since it is desirable to keep the curing temperature below 130° C. and preferably below 110° C. for proton exchange membrane fuel cells operating at low temperatures (less than 100° C.), a series of experiments were preformed to determine if it was possible to lower the peak exotherm temperature by changing the platinum catalyst concentration. From those experiments, i.e., inventive compositions 10 through 14, the peak exotherm temperature could be reduced from 137° C. to approximately 92° C. by increasing the amount of platinum from 20 to 60 mppm based on the concentration of alkenyl groups as shown in FIG. 12. This large drop in the peak exotherm temperature indicated that the activation temperature was significantly reduced, while the activation energy remained high. Thus, the experiments showed that the heat of reaction can be increased and the peak exotherm temperature can be reduced while maintaining a useful viscosity for screen-printing, liquid dispensing, liquid molding operations and other types of application methods. There is a practical limit to the benefit that can be derived from increasing the concentration of catalyst. The rate of change in the peak exotherm decreased dramatically above 60 mppm within this set of experiments.

If the concentration of catalyst were increased to as little as 15 mppm in comparative compositions 15 through 18 without trivinylcyclohexane, the formulation would gel within minutes during the mixing operation, as shown in Table 4. It was possible to affect this by reducing the amount of catalyst within the composition as shown in Table 4. When using higher catalyst levels without the addition of trivinylcyclohexane, it was difficult to manufacture material as a single component composition and apply compositions without the material gelling.

TABLE 4
Catalyst Concentration Affects On Inventive
Compositions Without Inhibitors

| | Compar. | Compar. | Compar. | Compar. |
|---|---|---|---|---|
| | Comp. | Comp. | Comp. | Comp. |
| Description | 15 | 16 | 17 | 18 |
| Alkenyl Terminated | 100 | 100 | 100 | 100 |
| Polyisobutylene | | | | |
| (5,000 Mn), grams | | | | |
| Polyalkyl Hydrogen | 6.8 | 6.8 | 6.8 | 6.8 |
| Siloxane (2,230 Mn) (1), | | | | |
| grams | | | | |
| Trivinylcyclohexane, | 0 | 0 | 0 | 0 |
| grams | | | | |
| Platinum Catalyst (2), | 8.0 | 6.0 | 4.0 | 2.0 |
| microliters | | | | |
| Parts per million of | 20 | 15 | 10 | 5 |
| Platinum per Alkenyl | | | | |
| Group (mppm) | | | | |
| Notes: | Gelled | Gelled | | |
| | Fast | Fast | | |
| Pot Life (Minutes) | 8 | 8 | 15 | 60 |

(1) CR-300, Available from Kaneka Corporation, Osaka, Japan.
(2) 0.1M Platinum (0)-1,3-Divinyl-1,1,3,3-tetramethyldisiloxane complex in xylene

The use of inhibitors can help reduce the change in viscosity as a function of time, however, inhibitors have the potential to diffuse or be extracted out of the composition when used within a fuel cell causing undesirable affects in the performance of the cell. These changes can include but are not limited to changes in the hydrophobic/hydrophilic balance and fuel cell catalyst, which are reflected in a decrease in the overall output of the device.

The unexpected stabilizing affects of trivinylcyclohexane allow the use of higher concentrations of platinum catalyst, the ability to manufacture compositions without gelling and the ability to improve stability using moieties that cross-link into the polymer network thereby reducing the diffusion or extraction of the species in the final application. Trivinylcyclohexane can also be used along with inhibitors that do not cross-link into the final network at low levels.

When trivinylcyclohexane was added to the inventive compositions, unexpectedly improvements in the shelf life of the mixed inventive compositions were observed. This is highlighted in Table 5 by comparing inventive compositions 20 through 24 with comparative composition 19. Inventive compositions 20 through 24 with trivinylcyclohexane experienced a slower increase in viscosity as a function of time when compared to comparative composition 19 that did not contain trivinylcyclohexane. For example, the comparative composition 19 shown in Table 5 without trivinylcyclohexane gelled during the mixing process at room temperature within minutes. The addition of trivinylcyclohexane at the same catalyst loading and higher remained liquid for a longer period of time providing a practical amount of time for applying or molding the material onto a substrate.

TABLE 5
Affect Of Trivinylcyclohexane On Stability

| | Compar. | Inv. | Inv. | Inv. | Inv. | Inv. |
|---|---|---|---|---|---|---|
| | Comp. | Comp. | Comp. | Comp. | Comp. | Comp. |
| Description | 19 | 20 | 21 | 22 | 23 | 24 |
| Alkenyl Terminated | 100 | 100 | 100 | 100 | 100 | 100 |
| Polyisobutylene (5,000 Mn), | | | | | | |
| grams | | | | | | |
| Polyalkyl Hydrogen Siloxane | 6.8 | 22.2 | 33.3 | 44.6 | 66.4 | 26.6 |
| (2,230 Mn) (1), grams | | | | | | |
| Trivinylcyclohexane, grams | 0 | 5 | 5 | 5 | 5 | 5 |
| Platinum Catalyst (2), | 8.0 | 26.1 | 26.1 | 26.1 | 26.1 | 78.2 |
| microliters | | | | | | |
| Parts per million of Platinum | 20 | 20 | 20 | 20 | 20 | 60 |
| per Alkenyl Group (mppm) | | | | | | |
| Molar Ratio of Si—H to Alkenyl | 1.2:1 | 1.0:1 | 1.5:1 | 2.0:1 | 3.0:1 | 1.2:1 |
| Notes: | Gelled | | | | | |
| | Fast | | | | | |
| Pot Life (Minutes) | 8 | >60 | >60 | >60 | >60 | >60 |

(1) CR-300, Available from Kaneka Corporation, Osaka, Japan.
(2) 0.1M Platinum (0)-1,3-Divinyl-1,1,3,3-tetramethyldisiloxane complex in xylene

### Example 3

### Formulated Physical Property Data

### (Compression Set, Hardness & Mechanical Properties)

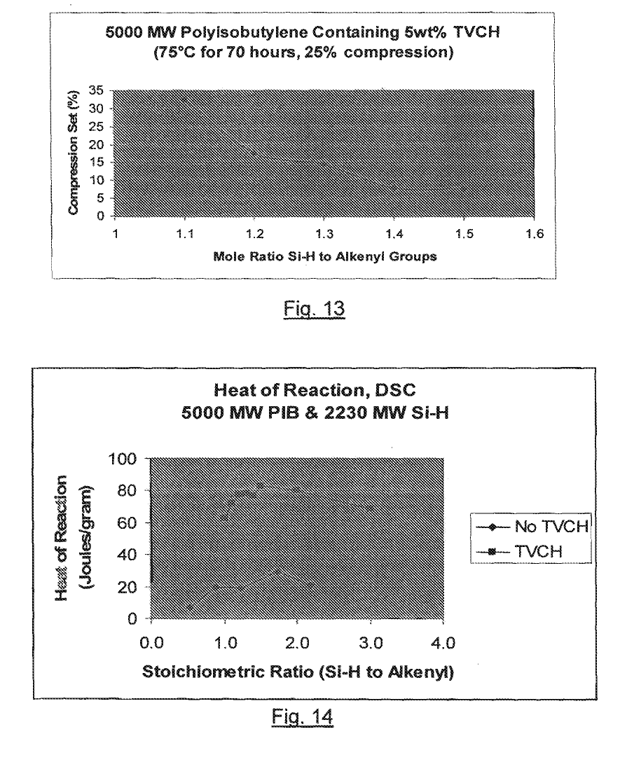

Inventive compositions 25 through 30 were prepared using a constant ratio of trivinylcyclohexane to alkenyl terminated polyisobutylene (PIB) while varying the amount of Si—H to the total number of alkenyl groups by varying the polyalkyl hydrogen siloxane content to measure the change in physical, mechanical and thermodynamic properties. The ratio of the number of “A” functional groups (N_{A}) to the number of “B” functional groups (N_{B}) is referred to as the stoichiometric imbalance (r=N_{A}/N_{B}). It was observed as shown in Table 6, Table 7 and FIG. 13 that as the stoichiometric imbalance increased, the ratio of Si—H to alkenyl groups increased, compression set values decreased while mechanical properties increased. Optimal properties were obtained at a stoichiometric imbalance of approximately 1.4 to 1.0 (Si—H to alkenyl groups). The absolute value of the compression set decreased dramatically to 8 percent, which is very low for an elastomer. This was completely unexpected.

Comparative composition 31 was prepared with the alkenyl terminated polyisobutylene (PIB) and the polyalkyl hydrogen siloxane at a molar ratio of 1.5:1 of Si—H to the total number of alkenyl groups. Comparative composition did not contain any trivinylcyclohexane. An inhibitor, i.e., 3,5-dimethyl-1-hexyne-ol, was added to comparative composition 31 to inhibit the cure rate of the composition so that the compression test could be performed. Without any inhibitor, the composition gelled within a very short time, i.e., a couple of minutes. Comparative Composition 31 had a compression set of 22 percent. As shown in Table 6, the inventive composition 30 had significantly improved compression set properties as compared to the comparative composition 31. The Si—H to alkenyl molar ratio for inventive composition 30 and comparative composition 31 were the same at 1.5:1.

It is generally expected in the art that gross stoichiometric imbalances lead to low molecular weight species that are unusable as high performance polymers. At a stoichiometric imbalance of r=0.67 (1.0/1.5) one would expect to obtain low molecular weight species, however, cross-linked networks were obtained with improved physical, mechanical and compression set properties.

TABLE 6
Compression Set For 5000 Mn Alkenyl
Polyisobutylene At 5 wt % Trivinylcyclohexane
And With 2230 Mn Polyalkyl Hydrogen Siloxane

| | Si—H to Alkenyl | Compression Set at |
|---|---|---|
| Description | Molar Ratio | 75° C. for 70 Hours |
| Inventive Composition 25 | 1.0:1 | n/a |
| Inventive Composition 26 | 1.1:1 | 32.6 |
| Inventive Composition 27 | 1.2:1 | 17.7 |
| Inventive Composition 28 | 1.3:1 | 14.7 |
| Inventive Composition 29 | 1.4:1 | 7.9 |
| Inventive Composition 30 | 1.5:1 | 7.8 |
| Comparative Composition 31 | 1.5:1 | 22.2 |

The increase in tensile strength, modulus, hardness and corresponding decrease in elongation at break was consistent with the increase in the cross-link density as the ratio of Si—H to alkenyl groups increased.

TABLE 7
Mechanical Properties As A
Function Of Si—H To Alkenyl Ratio

| | Inv. | Inv. | Inv. | Inv. | Inv. | Inv. |
|---|---|---|---|---|---|---|
| | Comp. | Comp. | Comp. | Comp. | Comp. | Comp. |
| Description | 25 | 26 | 27 | 28 | 29 | 30 |
| Si—H To Alkenyl Molar Ratio | 1.0:1 | 1.1:1 | 1.2:1 | 1.3:1 | 1.4:1 | 1.5:1 |
| Reaction Properties: | | | | | | |
| Exotherm Onset (° C.) | 59 | 54 | 55 | 53 | 50 | 70 |
| Exotherm Peak (° C.) | 88 | 87 | 87 | 85 | 96 | 92 |
| Heat of Reaction (Joules | 62 | 72 | 77 | 78 | 77 | 83 |
| per gram) | | | | | | |
| Physical Properties: | | | | | | |
| Cure Temp. (° C.) | 110 | 110 | 110 | 110 | 110 | 110 |
| Cure Time. (Min.) | 60 | 60 | 60 | 60 | 60 | 60 |
| Tensile Strength (psi) | 68 | 67 | 138 | 160 | 166 | 140 |
| 50% Modulus (psi) | 15 | 28 | 50 | 62 | 96 | 88 |
| Elongation at Break (%) | 108 | 89 | 101 | 95 | 83 | 76 |
| Shore “A” Hardness | 12 | 17 | 36 | 41 | 45 | 45 |
| Compression Set at 75° C. for | n/a | 33 | 18 | 15 | 8 | 8 |
| 70 Hours | | | | | | |

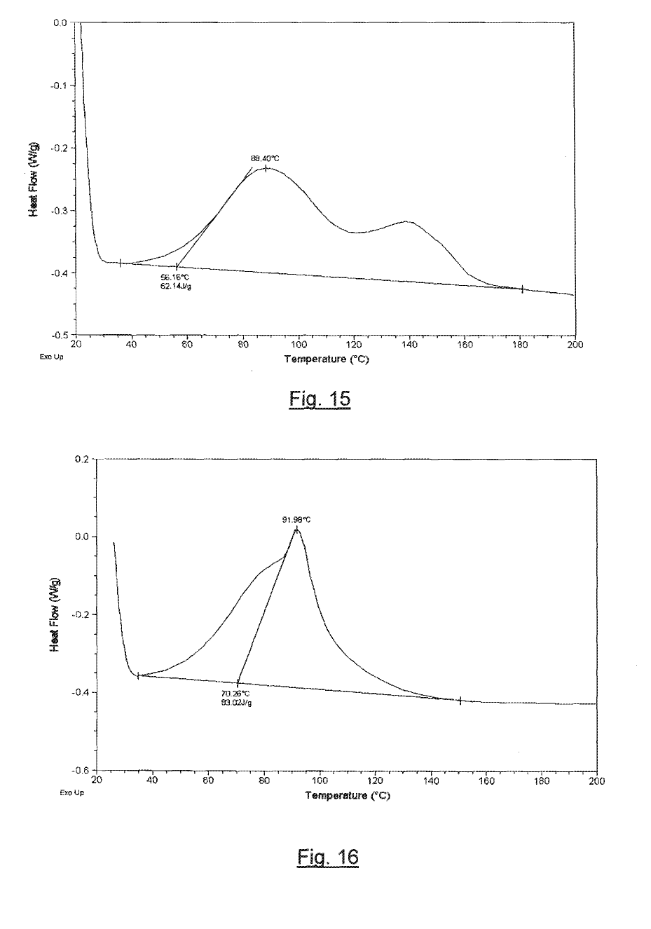

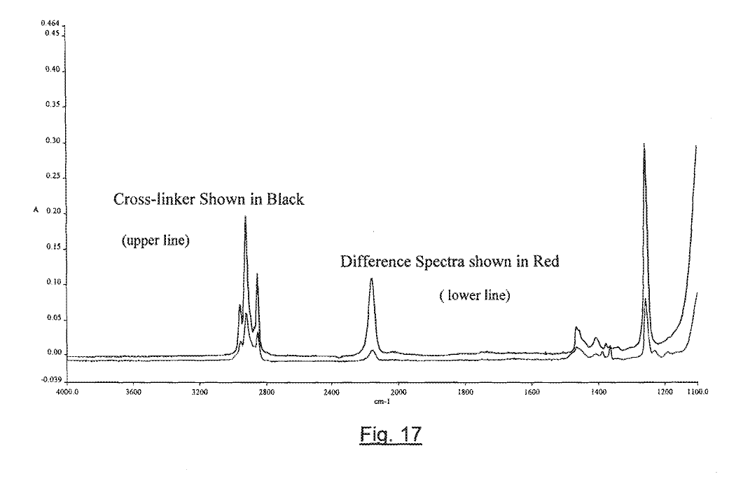

It was observed that optimal mechanical properties occur near the maximum value for the heat of reaction as shown in Table 7 and FIG. 14. It was also observed that at a stoichiometric ratio of 1 to 1, the enthalpy from the heat of reaction plotted as a function of temperature was bimodal with an upper temperature limit of 180° C., FIG. 15. Inventive compositions based on a stoichiometric imbalance had a single asymmetric curve with an upper temperature limit of approximately 140° C., FIG. 16. A lower temperature is better for fuel cells operating below 100° C. The majority of the reaction was completed under 120° C., which is desirable for low temperature proton exchange membrane fuel cells. The performance of the proton exchange membrane can be severely degraded at elevated temperatures; therefore it is desirable to maintain cure temperatures below 130° C. and more preferably below 120° C.

The infrared spectrums were compared for compositions with a 1:1 and 1.5:1 stoichiometric ratio using a mathematical subtraction method to validate that an excess concentration of Si—H is present in the cured network containing an excess amount of Si—H compare to a stoichiometric network. The subtraction spectrum was consistent with the spectra for the neat cross-linker from 4000 to 1200 cm⁻¹ and the peak associated with the Si—H bond was clearly present providing strong direct evidence of excess hydride. This excess hydride is also desirable as it is possible to improve the adhesion of the network to a substrate through covalent and/or secondary bonding forces via the Si—H moiety.

### Example 4

### Inventive Compositions with 1,9-decadiene;

An inventive composition with 1,9-decadiene and a bicyclic decadiene cross-linker was prepared as shown below in Table 8. The inventive composition demonstrated excellent reaction data, e.g., exothermic data and heat of reaction.

TABLE 9
Decadiene Addition To Difunctional Resins

| | Inventive |
|---|---|
| Description | Composition 32 |
| Alkenyl Terminated Polyisobutylene | 50 |
| (5,000 Mn), grams | |
| Bicyclic Decadiene Cross-linker (1), | 5 |
| grams | |
| 1,9-decadiene, grams | 9.4 |
| Platinum Catalyst (2), microliters | 4.6 |
| Parts per million of Platinum per | 5 |
| Alkenyl Group (mppm) | |
| Exotherm Start (° C.) | 59 |
| Exotherm Peak (° C.) | 86 |
| Heat of Reaction (Joules per gram) | 104.7 |

(1) Reaction product of 1,,9-decadiene and 2,4,6,8-tetramethylcyclotetrasiloxane.
(2) 0.1M Platinum (0)-1,3-Divinyl-1,1,3,3-tetramethyldisiloxane complex in xylene

1. An electrochemical cell comprising:
a first electrochemical cell component having a mating surface;
a cured sealant composition disposed over the mating surface of the first electrochemical ceil component, wherein the cured sealant composition comprises:
an alkenyl terminated diallyl polyisobutylene oligomer;
a silyl hardener having at least about two silicon hydride functional groups where only about one hydrogen atom, bonded is to a silicon atom; and
a hydrosilylation catalyst; and
a second electrochemical cell component having a mating surface abuttingly disposed over the cured sealant composition to provide a seal thereat.

2. The cell of claim 1, wherein the cured composition further comprises a polyfunctional alkenyl monomer,

3. The cell of claim 2, wherein the polyfunctional alkenyl monomer is selected from the group consisting of 1,9-decadiene, trivinylcyclohexane and combinations thereof.

4. The cell of claim 1, wherein the cured composition is adhesively bonded to the mating surface of the first cell, and further wherein the cured sealant composition is adhesively bonded to the mating surface of the second fuel cell.

5. The cell of claim 1, wherein the cured composition is adhesively bonded to the mating surface of the first cell, and further wherein the cured sealant composition is not adhesively bonded to the mating surface of the second fuel cell.

6. The cell of claim 1, wherein the first cell component is selected from the group consisting of a cathode flow field plate, an anode flow field plate, a gas diffusion layer, an anode catalyst layer, a cathode catalyst layer, a membrane electrolyte, a membrane-electrode-assembly frame, and combinations thereof.

7. The cell of claim 6, wherein the second cell component is selected from the group consisting of a cathode flow field plate, an anode flow field plate, a gas diffusion layer, an anode catalyst layer, a cathode catalyst layer, a membrane electrolyte, a membrane-electrode-assembly frame, and combinations thereof, provided that the second cell component is different from the first cell component.

8. The cell of claim 1, wherein the electrochemical cell is a fuel cell.

9. An electrochemical cell comprising:
a first electrochemical cell component having a mating surface;
a cured sealant composition disposed over the mating surface of the first electrochemical cell component, wherein the cured sealant composition comprises:
an alkenyl terminated polyisobutylene oligomer;
a polyfunctional alkenyl monomer;
a silyl hardener having at least about two silicon hydride functional groups; and
a hydrosilylation catalyst; and
a second electrochemical cell component having a mating surface abuttingly disposed over the cured sealant composition to provide a seal thereat.

10. A method for forming an electrochemical ceil comprising the steps of either:
I.
providing a first and a second electrochemical cell component each having a mating surface;
applying a curable sealant composition to the mating surface of at least one of the first electrochemical cell component or the second electrochemical cell component, wherein the curable sealant composition comprises:
an alkenyl terminated polyisobutylene oligomer;
a polyfunctional alkenyl monomer;
a silyl hardener having at least about two silicon hydride functional groups; and
a hydrosilylation catalyst;
curing the sealant composition; and
aligning the mating surface of the second electrochemical cell component with the mating surface of the first electrochemical cell component, or
II.
providing a first electrochemical cell component having a mating surface;
aligning a mating surface of a second electrochemical cell component with the mating surface of the first electrochemical cell component;
applying a curable sealant composition to at least a portion of the mating surface of at least one of the first or second electrochemical cell components, wherein the curable sealant composition comprises:
an alkenyl terminated polyisobutylene oligomer;
a silyl hardener having at least about, two silicon hydride functional groups; and
a hydrosilylation catalyst; and
curing the sealant composition to adhesively bond the first and second mating surfaces.

11. The method of claim 10, wherein the first cell component is selected from the group consisting of a cathode flow field plate, an anode flow field plate, a gas diffusion layer, an anode catalyst layer, a cathode catalyst layer, a membrane electrolyte, a membrane-electrode-assembly frame, and combinations thereof.

12. The method of claim 10, wherein the second cell component is selected from the group consisting of a cathode flow field plate, an anode flow field plate, a gas diffusion layer, an anode catalyst layer, a cathode catalyst layer, a membrane electrolyte, a membrane-electrode-assembly frame, and combinations thereof, provided that the second cell component is different from the first cell component.

13. The method of claim 10, wherein the electrochemical cell is a fuel cell.

14-21. (canceled)

22. An addition curable composition, comprising:
an alkenyl terminated polyisobutylene oligomer;
a polyfunctional alkenyl monomer;
a silyl hardener having at least about two silicon hydride functional groups; and
a hydrosilylation catalyst,

23. The composition of claim 22, wherein the polyfunctional alkenyl monomer is selected from the group consisting of 1,9-decadiene, trivinylcyclohexane and combinations thereof.

24. The composition of claim 22, wherein the silyl hardener comprises a bicyclic compound which is a reaction product of 1,9-decadiene and 2,4,6,8-tetramethylcyclotetrasiloxane.

25-33. (canceled)
